(19) United States
(12) Patent Application Publication
(10) Pub. No.: US 2025/0347895 A1
(43) Pub. Date: Nov. 13, 2025

(54) OPTICAL IMAGING LENS

(71) Applicant: Calin Technology Co., Ltd., Taichung City (TW)

(72) Inventors: SHU-CHUAN HSU, Taichung City (TW); FUN-RU LIN, Taichung City (TW)

(73) Assignee: Calin Technology Co., Ltd., Taichung City (TW)

(21) Appl. No.: 18/895,934

(22) Filed: Sep. 25, 2024

(30) Foreign Application Priority Data
May 9, 2024 (TW) 113117129

(51) Int. Cl. G02B 13/00; G02B 9/64

(52) U.S. Cl. CPC G02B 13/0045; G02B 9/64

(57) ABSTRACT

An optical imaging lens, in order from an object side to an image side along an optical axis, includes a first lens assembly, an aperture, and a second lens assembly. The first lens assembly consists of, in order from the object side to the image side along the optical axis, a first lens having negative refractive power, a second lens having positive refractive power, and a third lens having negative refractive power. The second lens assembly consists of, in order from the object side to the image side along the optical axis, a fourth lens having positive refractive power, a fifth lens having positive refractive power, a sixth lens having negative refractive power, a seventh lens having positive refractive power, an eighth lens having positive refractive power, and a ninth lens having negative refractive power.

### BACKGROUND OF THE INVENTION

### Technical Field

The present invention generally relates to an optical image capturing system, and more particularly to an optical imaging lens, which provides a better optical performance of low distortion and high image quality.

### Description of Related Art

In recent years, with popularization in portable electronic devices having camera functionalities, the demand for an optical image capturing system is raised gradually. The ordinary optical image capturing system is selected from a charge-coupled device (CCD) or a complementary metal-oxide-semiconductor sensor (CMOS Sensor). Besides, as advanced semiconductor manufacturing technology enables the minimization of the pixel size of the image sensing device, the development of the optical image capturing system towards the field of high pixels. Moreover, with the advancement in drones and driverless autonomous vehicles, Advanced Driver Assistance System (ADAS) plays an important role in the field of vehicle safety, collecting real-time environmental information through various lenses and sensors to provide the comprehensive insights of the driver. Furthermore, as the automotive lens changes with the temperature of an external application environment, the temperature requirements of the image quality of the automotive lens also increase. Therefore, the requirement for high imaging quality is rapidly raised.

Good imaging lenses generally have the advantages of low distortion, high resolution, etc. In practice, small size and cost must be considered. Therefore, it is a big problem for designers to design a lens with good imaging quality under various constraints.

### BRIEF SUMMARY OF THE INVENTION

In view of the reasons mentioned above, the primary objective of the present invention is to provide an optical imaging lens that provides a high image quality.

The present invention provides an optical imaging lens, in order from an object side to an image side along an optical axis, including a first lens assembly, an aperture, and a second lens assembly, wherein the first lens assembly consists of, in order from the object side to the image side along the optical axis, a first lens having negative refractive power, a second lens having positive refractive power, and a third lens having negative refractive power. The first lens is a biconcave lens. The second lens assembly consists of, in order from the object side to the image side along the optical axis, a fourth lens having positive refractive power, a fifth lens having positive refractive power, a sixth lens having negative refractive power, a seventh lens having positive refractive power, an eighth lens having positive refractive power, and a ninth lens having negative refractive power.

The present invention further provides an optical imaging lens, in order from an object side to an image side along an optical axis, including a first lens assembly, an aperture, and a second lens assembly, wherein the first lens assembly consists of, in order from the object side to the image side along the optical axis, a first lens having negative refractive power, a second lens, and a third lens. The first lens is a biconcave lens. An image-side surface of the second lens and an object-side surface of the third lens are adhered to form a compound lens having positive refractive power. The second lens assembly consists of, in order from the object side to the image side along the optical axis, a fourth lens, a fifth lens, a sixth lens, a seventh lens, an eighth lens, and a ninth lens. The fourth lens has positive refractive power. An image-side surface of the fifth lens and an object-side surface of the sixth lens are adhered to form a compound lens having negative refractive power. The seventh lens has positive refractive power. The eighth lens has positive refractive power. The ninth lens has negative refractive power.

The effect of the present invention lies in arranging at least nine lenses into an optical assembly for the optical imaging lens. In addition, the arrangement of the refractive powers and the conditions of the optical imaging lens of the present invention could achieve the effect of high image quality. Moreover, the optical imaging lens includes two compound lenses, which could significantly improve the chromatic aberration of the lens.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1A is a schematic view of the optical imaging lens according to a first embodiment of the present invention;

FIG. 1B is a diagram showing the longitudinal chromatic aberration of the optical imaging lens according to the first embodiment of the present invention;

FIG. 1C is a diagram showing the lateral chromatic aberration of the optical imaging lens according to the first embodiment of the present invention;

FIG. 2A is a schematic view of the optical imaging lens according to a second embodiment of the present invention;

FIG. 2B is a diagram showing the longitudinal chromatic aberration of the optical imaging lens according to the second embodiment of the present invention;

FIG. 2C is a diagram showing the lateral chromatic aberration of the optical imaging lens according to the second embodiment of the present invention;

FIG. 3A is a schematic view of the optical imaging lens according to a third embodiment of the present invention;

FIG. 3B is a diagram showing the longitudinal chromatic aberration of the optical imaging lens according to the third embodiment of the present invention; and

FIG. 3C is a diagram showing the lateral chromatic aberration of the optical imaging lens according to the third embodiment of the present invention.

### DETAILED DESCRIPTION OF THE INVENTION

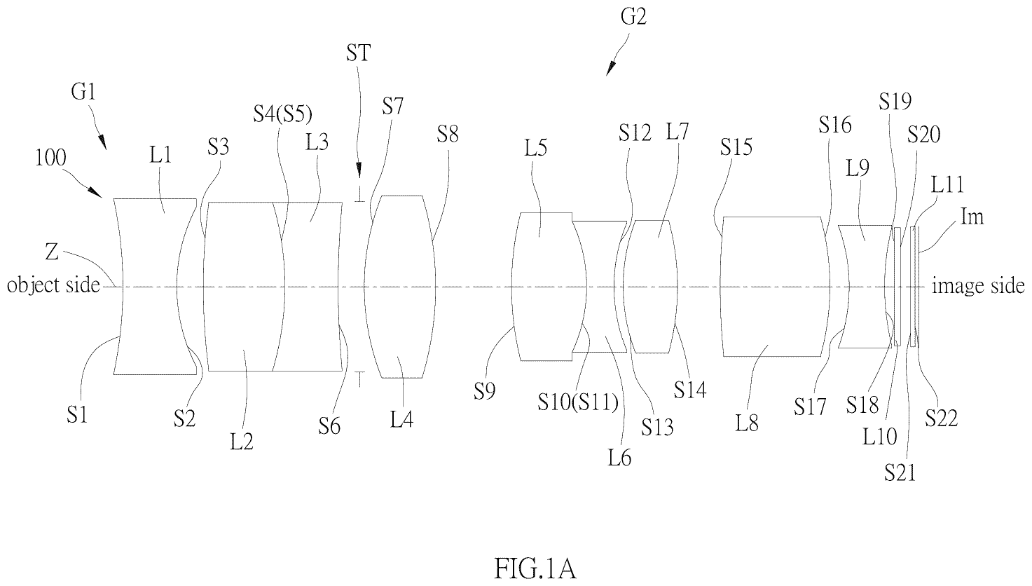

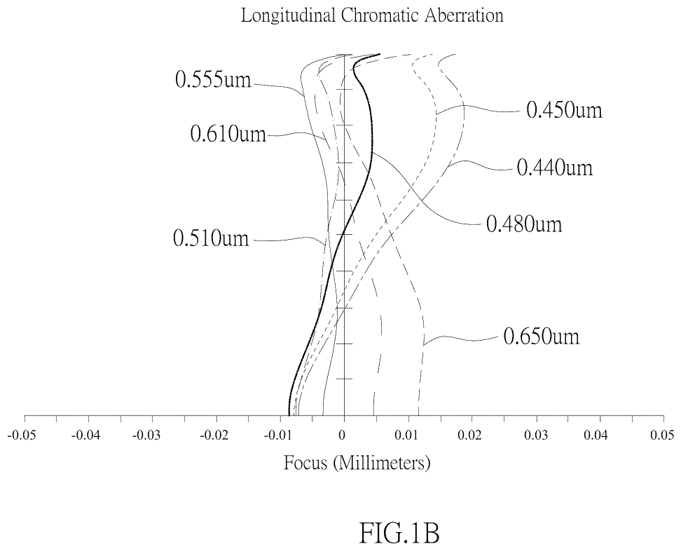

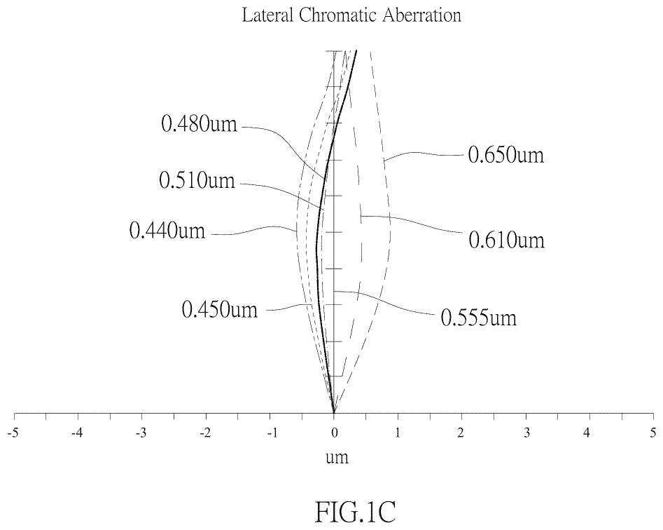

An optical imaging lens 100 according to a first embodiment of the present invention is illustrated in FIG. 1A, which includes, in order along an optical axis Z from an object side to an image side, a first lens assembly G1, an aperture ST, and a second lens assembly G2. In the first embodiment, the optical imaging lens 100 includes at least nine lenses, wherein the first lens assembly G1 consists of, in order along the optical axis Z from the object side to the image side, a first lens L1, a second lens L2, and a third lens L3. The second lens assembly G2 consists of, in order along the optical axis Z from the object side to the image side, a fourth lens L4, a fifth lens L5, a sixth lens L6, a seventh lens L7, an eighth lens L8, and a ninth lens L9.

The first lens L1 is a biconcave lens with negative refractive power, wherein both of an object-side surface S1 and an image-side surface S2 of the first lens L1 are spherical surfaces; the optical axis Z passes through both of the object-side surface S1 and the image-side surface S2.

The second lens L2 is a biconvex lens with positive refractive power, wherein both of an object-side surface S3 and an image-side surface S4 of the second lens L2 are spherical surfaces; the optical axis Z passes through both of the object-side surface S3 and the image-side surface S4. In the first embodiment, a space is provided between the image-side surface S2 of the first lens L1 and the object-side surface S3 of the second lens L2. In other words, the image-side surface S2 of the first lens L1 and the object-side surface S3 of the second lens L2 are not adhered.

The third lens L3 is a biconcave lens with negative refractive power, wherein both of an object-side surface S5 and an image-side surface S6 of the third lens L3 are spherical surfaces; the optical axis Z passes through both of the object-side surface S5 and the image-side surface S6. In the first embodiment, the object-side surface S5 of the third lens L3 and the image-side surface S4 of the second lens L2 are correspondingly adhered to form a compound lens having positive refractive power.

The fourth lens L4 is a biconvex lens with positive refractive power, wherein both of an object-side surface S7 and an image-side surface S8 of the fourth lens L4 are aspheric surfaces; the optical axis Z passes through both of the object-side surface S7 and the image-side surface S8. In the first embodiment, a space is provided between the image-side surface S6 of the third lens L3 and the object-side surface S7 of the fourth lens L4. In other words, the image-side surface S6 of the third lens L3 and the object-side surface S7 of the fourth lens L4 are not adhered.

The fifth lens L5 is a biconvex lens with positive refractive power, wherein both of an object-side surface S9 and an image-side surface S10 of the fifth lens L5 are spherical surfaces; the optical axis Z passes through both of the object-side surface S9 and the image-side surface S10. In the first embodiment, a space is provided between the image-side surface S8 of the fourth lens L4 and the object-side surface S9 of the fifth lens L5. In other words, the image-side surface S8 of the fourth lens L4 and the object-side surface S9 of the fifth lens L5 are not adhered.

The sixth lens L6 is a biconcave lens with negative refractive power, wherein both of an object-side surface S11 and an image-side surface S12 of the sixth lens L6 are spherical surfaces; the optical axis Z passes through both of the object-side surface S11 and the image-side surface S12. In the first embodiment, the object-side surface S11 of the sixth lens L6 and the image-side surface S10 of the fifth lens L5 are correspondingly adhered to form a compound lens having negative refractive power.

The seventh lens L7 is a biconvex lens with positive refractive power, wherein both of an object-side surface S13 and an image-side surface S14 of the seventh lens L7 are spherical surfaces; the optical axis Z passes through both of the object-side surface S13 and the image-side surface S14. In the first embodiment, a space is provided between the image-side surface S12 of the sixth lens L6 and the object-side surface S13 of the seventh lens L7. In other words, the image-side surface S12 of the sixth lens L6 and the object-side surface S13 of the seventh lens L7 are not adhered.

The eighth lens L8 is a biconvex lens with positive refractive power, wherein both of an object-side surface S15 and an image-side surface S16 of the eighth lens L8 are spherical surfaces; the optical axis Z passes through both of the object-side surface S15 and the image-side surface S16. In the first embodiment, a space is provided between the image-side surface S14 of the seventh lens L7 and the object-side surface S15 of the eighth lens L8. In other words, the image-side surface S14 of the seventh lens L7 and the object-side surface S15 of the eighth lens L8 are not adhered.

The ninth lens L9 is a biconcave lens with negative refractive power, wherein both of an object-side surface S17 and an image-side surface S18 of the ninth lens L9 are spherical surfaces; the optical axis Z passes through both of the object-side surface S17 and the image-side surface S18. A space is provided between the image-side surface S16 of the eighth lens L8 and the object-side surface S17 of the ninth lens L9. In other words, the image-side surface S16 of the eighth lens L8 and the object-side surface S17 of the ninth lens L9 are not adhered.

Additionally, the optical imaging lens 100 further includes an infrared filter L10 and a protective glass L11, wherein the infrared filter L10 forms an object-side surface S19 facing the object side and an image-side surface S20 facing the image side. The infrared filter L10 is disposed on one side of the image-side surface S18 of the ninth lens L9, thereby restricting infrared rays passing through the optical imaging lens 100 to improve the quality and fidelity of the image. The protective glass L11 forms an object-side surface S21 facing the object side and an image-side surface S22 facing the image side. The protective glass L11 is disposed on one side of the infrared filter L10 and is located between the infrared filter L10 and an image plane Im to protect the infrared filter L10.

In order to keep the optical imaging lens 100 in good optical performance and high imaging quality, the optical imaging lens 100 satisfies:

$$- 1.1 < F / f 1 < - 0.4 ; \qquad ( 1 )$$

$$0.45 < F / f 2 < 0.9 , - 0.68 < F / f 3 < - 0.01 , 0.28 < F / f 23 < 0.7 ; \qquad ( 2 )$$

$$0.39 < F / f 4 < 0.96 ; \qquad ( 3 )$$

$$0.78 < F / f 5 < 1.1 , - 2.4 < F / f 6 < - 1.3 , - 1.2 < F / f 56 < - 0.38 ; \qquad ( 4 )$$

$$0.48 < F / f 7 < 1.23 ; \qquad ( 5 )$$

$$0.38 < F / f 8 < 1.1 ; \qquad ( 6 )$$

$$- 1.38 < F / f 9 < - 0.62 ; \qquad ( 7 )$$

$$- 0.7 < F / fg 1 < - 0.01 ; \qquad ( 8 )$$

$$0.6 < F / fg 2 < 1.15 . \qquad ( 9 )$$

wherein F is a focal length of the optical imaging lens 100; f1 is a focal length of the first lens L1; f2 is a focal length of the second lens L2; f3 is a focal length of the third lens L3; f23 is a focal length (cemented focal length) of the compound lens formed by adhering the second lens L2 and the third lens L3; f4 is a focal length of the fourth lens L4; f5 is a focal length of the fifth lens L5; f6 is a focal length of the sixth lens L6; f56 is a focal length (cemented focal length) of the compound lens formed by adhering the fifth lens L5 and the sixth lens L6; f7 is a focal length of the seventh lens L7; f8 is a focal length of the eighth lens L8; f9 is a focal length of the ninth lens L9; fg1 is a focal length of the first lens assembly G1; fg2 is a focal length of the second lens assembly G2.

Parameters of the optical imaging lens 100 of the first embodiment of the present invention are listed in following Table 1, including the focal length F of the optical imaging lens 100 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, the focal length (cemented focal length) of the compound lens formed by adhering the second lens L2 and the third lens L3, and the focal length (cemented focal length) of the compound lens formed by adhering the fifth lens L5 and the sixth lens L6, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 1
F = 23.00 mm; Fno = 1.80; FOV = 34.61 deg

| | | | | | | Cemented | |
|---|---|---|---|---|---|---|---|
| | | | | | Focal | focal | |
| Surface | R(mm) | D(mm) | Nd | Vd | length | length | Note |
| S1 | −43.62 | 6.05 | 1.58 | 40.75 | −22.32 | | First lens L1 |
| S2 | 19.42 | 3.00 | | | | | |
| S3 | 71.89 | 9.30 | 1.85 | 24.80 | 27.60 | 61.96 | Second lens L2 |
| S4, S5 | −33.02 | 6.03 | 1.55 | 45.78 | −45.15 | | Third lens L3 |
| S6 | 105.18 | 2.42 | | | | | |
| ST | INFINITY | 0.50 | | | | | Aperture ST |
| S7 | 28.69 | 8.09 | 1.58 | 59.39 | 27.46 | | Fourth lens L4 |
| S8 | −32.46 | 8.66 | | | | | |
| S9 | 34.86 | 8.50 | 1.50 | 81.55 | 24.65 | −21.41 | Fifth lens L5 |
| S10, S11 | −17.37 | 3.14 | 1.85 | 24.80 | −10.17 | | Sixth lens L6 |
| S12 | 18.85 | 1.01 | | | | | |
| S13 | 20.77 | 6.15 | 1.62 | 57.05 | 20.19 | | Seventh lens L7 |
| S14 | −28.26 | 4.83 | | | | | |
| S15 | 74.77 | 12.44 | 1.96 | 17.47 | 23.64 | | Eighth lens L8 |
| S16 | −29.89 | 2.20 | | | | | |
| S17 | −19.99 | 3.99 | 1.59 | 35.31 | −18.62 | | Ninth lens L9 |
| S18 | 26.47 | 1.13 | | | | | |
| S19 | INFINITY | 0.70 | 1.52 | 64.17 | | | Infrared Filter |
| | | | | | | | L10 |
| S20 | INFINITY | 1.16 | | | | | |
| S21 | INFINITY | 0.50 | 1.52 | 64.17 | | | Protective Glass |
| | | | | | | | L11 |
| S22 | INFINITY | 0.44 | | | | | |
| Im | INFINITY | | | | | | Image Plane Im |

It could be seen from Table 1 that, in the first embodiment, the focal length F of the optical imaging lens 100 is 23.00 mm, and the Fno is 1.80, and the FOV is 34.61 degrees, wherein the focal length f1 of the first lens L1 is −22.32 mm; the focal length f2 of the second lens L2 is 27.60 mm; the focal length f3 of the third lens L3 is −45.15 mm; the focal length f4 of the fourth lens L4 is 27.46 mm; the focal length f5 of the fifth lens L5 is 24.65 mm; the focal length f6 of the sixth lens L6 is −10.17 mm; the focal length 7 of the seventh lens L7 is 20.19 mm; the focal length f8 of the eighth lens L8 is 23.64 mm; the focal length f9 of the ninth lens L9 is −18.62 mm; the focal length f23 (cemented focal length) of the compound lens formed by adhering the second lens L2 and the third lens L3 is 61.96 mm; the focal length f56 (cemented focal length) of the compound lens formed by adhering the fifth lens L5 and the sixth lens L6 is −21.41 mm; the focal length fg1 of the first lens assembly G1 is −39.04 mm; the focal length fg2 of the second lens assembly G2 is 22.03 mm.

Additionally, based on the above detailed parameters, detailed values of the aforementioned conditions (1) to (9) in the first embodiment are as follows:

$$F / f 1 = - 1.03 ; \qquad ( 1 )$$

$$F / f 2 = 0.833 , F / f 3 = - 0.509 , F / f 23 = 0.371 ; \qquad ( 2 )$$

$$F / f 4 = 0.838 ; \qquad ( 3 )$$

$$F / f 5 = 0.933 , F / f 6 = - 2.262 , F / f 56 = - 1.074 ; \qquad ( 4 )$$

$$F / f 7 = 1.139 ; \qquad ( 5 )$$

$$F / f 8 = 0.973 ; \qquad ( 6 )$$

$$F / f 9 = - 1.235 ; \qquad ( 7 )$$

$$F / fg 1 = - 0.589 ; \qquad ( 8 )$$

$$F / fg 2 = 1.044 . \qquad ( 9 )$$

With the parameters from Table 1, in the first embodiment, the focal length fg1 of the first lens assembly G1, the focal length fg2 of the second lens assembly G2, the focal length of each lens, the focal length (cemented focal length) of the compound lens formed by adhering the second lens L2 and the third lens L3, and the focal length (cemented focal length) of the compound lens formed by adhering the fifth lens L5 and the sixth lens L6 satisfy the aforementioned conditions (1) to (9) of the optical imaging lens 100.

Additionally, the optical imaging lens 100 further satisfies:

$$f / ( f 1 + f 2 + f 3 ) = - 0.58 ; f / ( f 4 + f 5 + f 6 + f 7 + f 8 + f 9 ) = 0.34 .$$

Moreover, an aspheric surface contour shape Z of each of the object-side surface S7 of the fourth lens L4, and the image-side surface S8 of the fourth lens L4 according to the first embodiment could be obtained by following formula:

$$Z = \frac{{ch}^{2}}{1 + \sqrt{1 - ( 1 + k ) {c}^{2} {h}^{2}}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14 and A16 respectively represents different order coefficient of h.

In the optical imaging lens 100 according to the first embodiment, the conic constant k of each of the aspheric surfaces and the different order coefficient of A2, A4, A6, A8, A10, A12, A14, and A16 are listed in following Table 2:

TABLE 2

| Surface | S7 | S8 |
|---|---|---|
| k | 0.0000E+00 | 0.0000E+00 |
| A2 | 0.0000E+00 | 0.0000E+00 |
| A4 | 9.1603E−07 | 6.7160E−06 |
| A6 | 2.1895E−08 | −4.4846E−10 |
| A8 | 4.2758E−10 | 1.4180E−09 |
| A10 | −1.4574E−12 | −2.1572E−11 |
| A12 | −3.0850E−15 | 2.3598E−13 |
| A14 | 2.4878E−16 | −1.2230E−15 |
| A16 | −8.28662E−19 | 3.10909E−18 |

Taking optical simulation data to verify the imaging quality of the optical imaging lens 100, wherein FIG. 1B is a diagram showing the longitudinal chromatic aberration according to the first embodiment. From FIG. 1B, it could be observed that the curves formed by each wavelength are close to one another, thereby significantly enhancing chromatic aberration. The skewness of each curve shows that the deviation of the imaging points of off-axis rays is controlled within the range of ±0.02 millimeters. Therefore, in the first embodiment, chromatic aberration for different wavelengths is significantly improved.

The lateral chromatic aberration according to the first embodiment is illustrated in FIG. 1C. From FIG. 1C, it could be observed that the lateral chromatic aberration of both the shortest wavelength and the longest wavelength irradiating on the image plane is less than 1 micrometers, indicating that the optical imaging lens 100 has low lateral chromatic aberration. The rays of different wavelengths tend to converge at the image plane, thereby improving color accuracy and image quality.

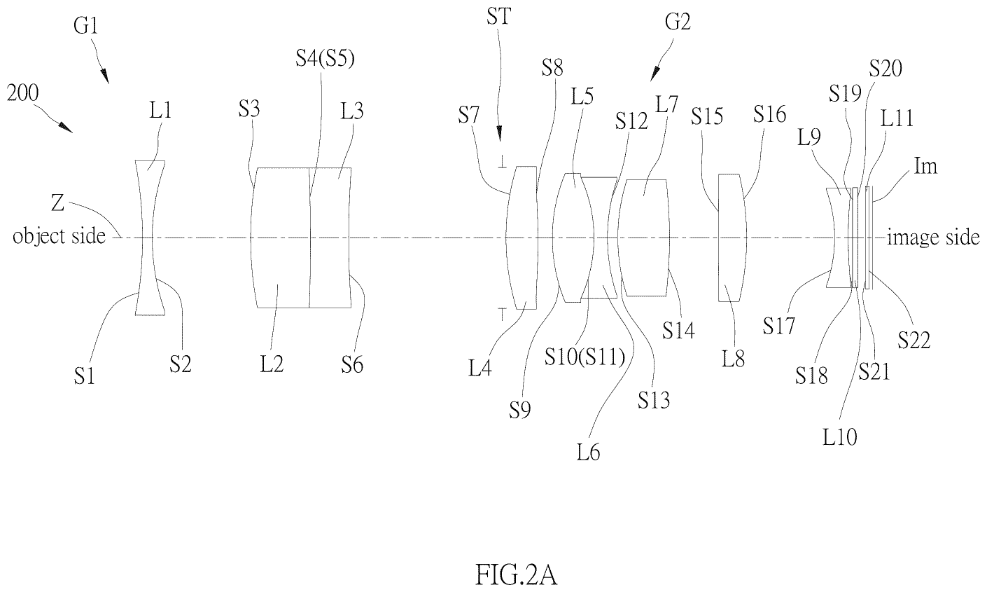

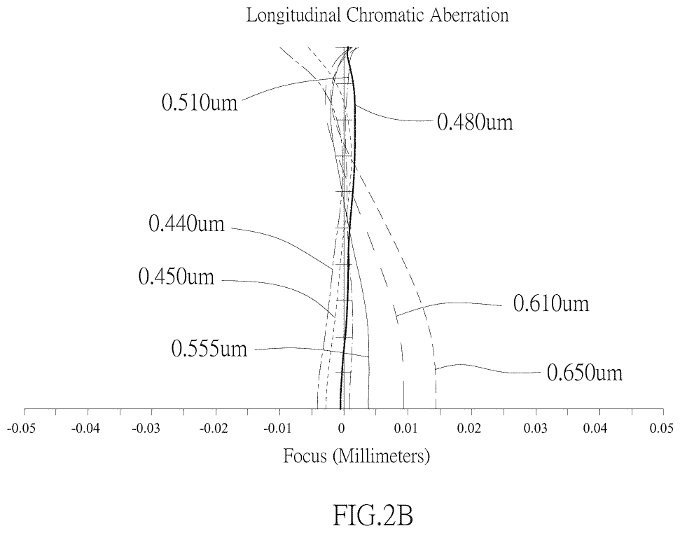

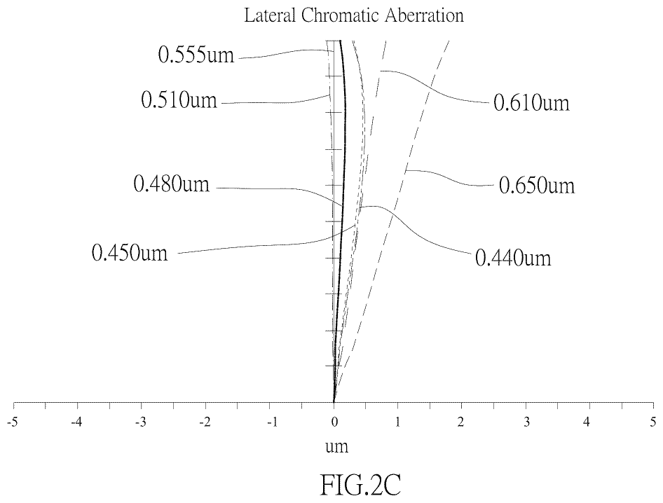

An optical imaging lens 200 according to a second embodiment of the present invention is illustrated in FIG. 2A, which includes, in order along an optical axis Z from an object side to an image side, a first lens assembly G1, an aperture ST, and a second lens assembly G2. In the second embodiment, the optical imaging lens 200 includes at least nine lenses, wherein the first lens assembly G1 consists of, in order along the optical axis Z from the object side to the image side, a first lens L1, a second lens L2, and a third lens L3. The second lens assembly G2 consists of, in order along the optical axis Z from the object side to the image side, a fourth lens L4, a fifth lens L5, a sixth lens L6, a seventh lens L7, an eighth lens L8, and a ninth lens L9.

The first lens L1 is a biconcave lens with negative refractive power, wherein both of an object-side surface S1 and an image-side surface S2 of the first lens L1 are spherical surfaces; the optical axis Z passes through both of the object-side surface S1 and the image-side surface S2.

The second lens L2 is a biconvex lens with positive refractive power, wherein both of an object-side surface S3 and an image-side surface S4 of the second lens L2 are spherical surfaces; the optical axis Z passes through both of the object-side surface S3 and the image-side surface S4. In the second embodiment, a space is provided between the image-side surface S2 of the first lens L1 and the object-side surface S3 of the second lens L2. In other words, the image-side surface S2 of the first lens L1 and the object-side surface S3 of the second lens L2 are not adhered.

The third lens L3 is a biconcave lens with negative refractive power, wherein both of an object-side surface S5 and an image-side surface S6 of the third lens L3 are spherical surfaces; the optical axis Z passes through both of the object-side surface S5 and the image-side surface S6. In the second embodiment, the object-side surface S5 of the third lens L3 and the image-side surface S4 of the second lens L2 are correspondingly adhered to form a compound lens having positive refractive power.

The fourth lens L4 is a biconvex lens with positive refractive power, wherein both of an object-side surface S7 and an image-side surface S8 of the fourth lens L4 are aspheric surfaces; the optical axis Z passes through both of the object-side surface S7 and the image-side surface S8. In the second embodiment, a space is provided between the image-side surface S6 of the third lens L3 and the object-side surface S7 of the fourth lens L4. In other words, the image-side surface S6 of the third lens L3 and the object-side surface S7 of the fourth lens L4 are not adhered.

The fifth lens L5 is a biconvex lens with positive refractive power, wherein both of an object-side surface S9 and an image-side surface S10 of the fifth lens L5 are spherical surfaces; the optical axis Z passes through both of the object-side surface S9 and the image-side surface S10. In the second embodiment, a space is provided between the image-side surface S8 of the fourth lens L4 and the object-side surface S9 of the fifth lens L5. In other words, the image-side surface S8 of the fourth lens L4 and the object-side surface S9 of the fifth lens L5 are not adhered.

The sixth lens L6 is a biconcave lens with negative refractive power, wherein both of an object-side surface S11 and an image-side surface S12 of the sixth lens L6 are spherical surfaces; the optical axis Z passes through both of the object-side surface S11 and the image-side surface S12. In the second embodiment, the object-side surface S11 of the sixth lens L6 and the image-side surface S10 of the fifth lens L5 are correspondingly adhered to form a compound lens having negative refractive power.

The seventh lens L7 is a biconvex lens with positive refractive power, wherein both of an object-side surface S13 and an image-side surface S14 of the seventh lens L7 are spherical surfaces; the optical axis Z passes through both of the object-side surface S13 and the image-side surface S14. In the second embodiment, a space is provided between the image-side surface S12 of the sixth lens L6 and the object-side surface S13 of the seventh lens L7. In other words, the image-side surface S12 of the sixth lens L6 and the object-side surface S13 of the seventh lens L7 are not adhered.

The eighth lens L8 is a biconvex lens with positive refractive power, wherein both of an object-side surface S15 and an image-side surface S16 of the eighth lens L8 are spherical surfaces; the optical axis Z passes through both of the object-side surface S15 and the image-side surface S16. In the second embodiment, a space is provided between the image-side surface S14 of the seventh lens L7 and the object-side surface S15 of the eighth lens L8. In other words, the image-side surface S14 of the seventh lens L7 and the object-side surface S15 of the eighth lens L8 are not adhered.

The ninth lens L9 is a biconcave lens with negative refractive power, wherein both of an object-side surface S17 and an image-side surface S18 of the ninth lens L9 are spherical surfaces; the optical axis Z passes through both of the object-side surface S17 and the image-side surface S18. A space is provided between the image-side surface S16 of the eighth lens L8 and the object-side surface S17 of the ninth lens L9. In other words, the image-side surface S16 of the eighth lens L8 and the object-side surface S17 of the ninth lens L9 are not adhered.

Additionally, the optical imaging lens 200 further includes an infrared filter L10 and a protective glass L11, wherein the infrared filter L10 forms an object-side surface S19 facing the object side and an image-side surface S20 facing the image side. The infrared filter L10 is disposed on one side of the image-side surface S18 of the ninth lens L9, thereby restricting infrared rays passing through the optical imaging lens 200 to improve the quality and fidelity of the image. The protective glass L11 forms an object-side surface S21 facing the object side and an image-side surface S22 facing the image side. The protective glass L11 is disposed on one side of the infrared filter L10 and is located between the infrared filter L10 and an image plane Im to protect the infrared filter L10.

In order to keep the optical imaging lens 200 in good optical performance and high imaging quality, the optical imaging lens 200 satisfies:

$$- 1.1 < F / f 1 < - 0.4 ; \qquad ( 1 )$$

$$0.45 < F / f 2 < 0.9 , - 0.68 < F / f 3 < - 0.01 , 0.28 < F / f 23 < 0.7 ; \qquad ( 2 )$$

$$0.39 < F / f 4 < 0.96 ; \qquad ( 3 )$$

$$0.78 < F / f 5 < 1.1 , - 2.4 < F / f 6 < - 1.3 , - 1.2 < F / f 56 < - 0.38 ; \qquad ( 4 )$$

$$0.48 < F / f 7 < 1.23 ; \qquad ( 5 )$$

$$0.38 < F / f 8 < 1.1 ; \qquad ( 6 )$$

$$- 1.38 < F / f 9 < - 0.62 ; \qquad ( 7 )$$

$$- 0.7 < F / fg 1 < - 0.01 ; \qquad ( 8 )$$

$$0.6 < F / fg 2 < 1.15 . \qquad ( 9 )$$

wherein F is a focal length of the optical imaging lens 200; f1 is a focal length of the first lens L1; f2 is a focal length of the second lens L2; f3 is a focal length of the third lens L3; f23 is a focal length (cemented focal length) of the compound lens formed by adhering the second lens L2 and the third lens L3; f4 is a focal length of the fourth lens L4; f5 is a focal length of the fifth lens L5; f6 is a focal length of the sixth lens L6; f56 is a focal length (cemented focal length) of the compound lens formed by adhering the fifth lens L5 and the sixth lens L6; f7 is a focal length of the seventh lens L7; f8 is a focal length of the eighth lens L8; f9 is a focal length of the ninth lens L9; fg1 is a focal length of the first lens assembly G1; fg2 is a focal length of the second lens assembly G2.

Parameters of the optical imaging lens 200 of the second embodiment of the present invention are listed in following Table 3, including the focal length F of the optical imaging lens 200 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, the focal length (cemented focal length) of the compound lens formed by adhering the second lens L2 and the third lens L3, and the focal length (cemented focal length) of the compound lens formed by adhering the fifth lens L5 and the sixth lens L6, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 3
F = 22.10 mm; Fno = 1.74; FOV = 36.30 deg

| | | | | | | Cemented | |
|---|---|---|---|---|---|---|---|
| | | | | | Focal | focal | |
| Surface | R(mm) | D(mm) | Nd | Vd | length | length | Note |
| S1 | −57.84 | 1.39 | 1.52 | 52.43 | −37.27 | | First lens L1 |
| S2 | 29.17 | 13.01 | | | | | |
| S3 | 44.48 | 8.00 | 1.85 | 24.80 | 43.55 | 58.57 | Second lens L2 |
| S4, S5 | −209.35 | 5.10 | 1.55 | 45.78 | −147.87 | | Third lens L3 |
| S6 | 133.41 | 20.38 | | | | | |
| ST | INFINITY | 0.50 | | | | | Aperture ST |
| S7 | 40.59 | 4.24 | 1.58 | 59.39 | 48.40 | | Fourth lens L4 |
| S8 | −89.03 | 1.93 | | | | | |
| S9 | 22.03 | 5.51 | 1.50 | 81.55 | 21.63 | −36.04 | Fifth lens L5 |
| S10, S11 | −19.25 | 1.80 | 1.85 | 24.80 | −12.13 | | Sixth lens L6 |
| S12 | 23.43 | 1.41 | | | | | |
| S13 | 25.47 | 6.86 | 1.57 | 50.80 | 32.25 | | Seventh lens L7 |
| S14 | −59.98 | 6.45 | | | | | |
| S15 | 500.00 | 3.76 | 1.96 | 17.47 | 35.04 | | Eighth lens L8 |
| S16 | −35.90 | 11.70 | | | | | |
| S17 | −18.79 | 1.80 | 1.57 | 42.82 | −24.84 | | Ninth lens L9 |
| S18 | 58.28 | 0.58 | | | | | |
| S19 | INFINITY | 0.70 | 1.52 | 64.17 | | | Infrared Filter |
| | | | | | | | L10 |
| S20 | INFINITY | 1.00 | | | | | |
| S21 | INFINITY | 0.50 | 1.52 | 64.17 | | | Protective Glass |
| | | | | | | | L11 |
| S22 | INFINITY | 0.44 | | | | | |
| Im | INFINITY | | | | | | Image Plane Im |

It could be seen from Table 3 that, in the second embodiment, the focal length F of the optical imaging lens 200 is 22.10 mm, and the Fno is 1.74, and the FOV is 36.30 degrees, wherein the focal length f1 of the first lens L1 is −37.27 mm; the focal length f2 of the second lens L2 is 43.55 mm; the focal length f3 of the third lens L3 is −147.87 mm; the focal length f4 of the fourth lens L4 is 48.40 mm; the focal length f5 of the fifth lens L5 is 21.63 mm; the focal length f6 of the sixth lens L6 is −12.13 mm; the focal length f7 of the seventh lens L7 is 32.25 mm; the focal length f8 of the eighth lens L8 is 35.04 mm; the focal length f9 of the ninth lens L9 is −24.84 mm; the focal length f23 (cemented focal length) of the compound lens formed by adhering the second lens L2 and the third lens L3 is 58.57 mm; the focal length f56 (cemented focal length) of the compound lens formed by adhering the fifth lens L5 and the sixth lens L6 is −36.04 mm; the focal length fg1 of the first lens assembly G1 is −231.15 mm; the focal length fg2 of the second lens assembly G2 is 28.26 mm.

Additionally, based on the above detailed parameters, detailed values of the aforementioned conditions (1) to (9) in the second embodiment are as follows:

$$F / f 1 = - 0.593 ; \qquad ( 1 )$$

$$F / f 2 = 0.507 , F / f 3 = - 0.149 , F / f 23 = 0.377 ; \qquad ( 2 )$$

$$F / f 4 = 0.457 ; \qquad ( 3 )$$

$$F / f 5 = 1.022 , F / f 6 = - 1.822 , F / f 56 = - 0.613 ; \qquad ( 4 )$$

$$F / f 7 = 0.685 ; \qquad ( 5 )$$

$$F / f 8 = 0.631 ; \qquad ( 6 )$$

$$F / f 9 = - 0.89 ; \qquad ( 7 )$$

$$F / fg 1 = - 0.096 ; \qquad ( 8 )$$

$$F / fg 2 = 0.782 . \qquad ( 9 )$$

With the parameters from Table 3, in the second embodiment, the focal length fg1 of the first lens assembly G1, the focal length fg2 of the second lens assembly G2, the focal length of each lens, the focal length (cemented focal length) of the compound lens formed by adhering the second lens L2 and the third lens L3, and the focal length (cemented focal length) of the compound lens formed by adhering the fifth lens L5 and the sixth lens L6 satisfy the aforementioned conditions (1) to (9) of the optical imaging lens 200.

Additionally, the optical imaging lens 200 further satisfies:

$$f / ( f 1 + f 2 + f 3 ) = - 0.16 ; f / ( f 4 + f 5 + f 6 + f 7 + f 8 + f 9 ) = 0.22 .$$

Moreover, an aspheric surface contour shape Z of each of the object-side surface S7 of the fourth lens L4, and the image-side surface S8 of the fourth lens L4 according to the second embodiment could be obtained by following formula:

$$Z = \frac{{ch}^{2}}{1 + \sqrt{1 - ( 1 + k ) {c}^{2} {h}^{2}}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14 and A16 respectively represents different order coefficient of h.

In the optical imaging lens 200 according to the second embodiment, the conic constant k of each of the aspheric surfaces and the different order coefficient of A2, A4, A6, A8, A10, A12, A14, and A16 are listed in following Table 4:

TABLE 4

| Surface | S7 | S8 |
|---|---|---|
| k | 0.0000E+00 | 0.0000E+00 |
| A2 | 0.0000E+00 | 0.0000E+00 |
| A4 | 2.2347E−05 | 2.1432E−05 |
| A6 | 1.1508E−07 | 9.2162E−08 |
| A8 | 6.3545E−10 | 1.3321E−09 |
| A10 | 2.1150E−12 | −1.3994E−11 |
| A12 | −7.1285E−15 | 2.3016E−13 |
| A14 | 2.2173E−16 | −1.5638E−15 |
| A16 | 1.03214E−18 | 8.1306E−18 |

Taking optical simulation data to verify the imaging quality of the optical imaging lens 200, wherein FIG. 2B is a diagram showing the longitudinal chromatic aberration according to the second embodiment. From FIG. 2B, it could be observed that the curves formed by each wavelength are close to one another, thereby significantly enhancing chromatic aberration. The skewness of each curve shows that the deviation of the imaging points of off-axis rays is controlled within the range of ±0.02 millimeters. Therefore, in the second embodiment, chromatic aberration for different wavelengths is significantly improved.

The lateral chromatic aberration according to the second embodiment is illustrated in FIG. 2C. From FIG. 2C, it could be observed that the lateral chromatic aberration of both the shortest wavelength and the longest wavelength irradiating on the image plane is less than 2 micrometers, indicating that the optical imaging lens 200 has low lateral chromatic aberration. The rays of different wavelengths tend to converge at the image plane, thereby improving color accuracy and image quality.

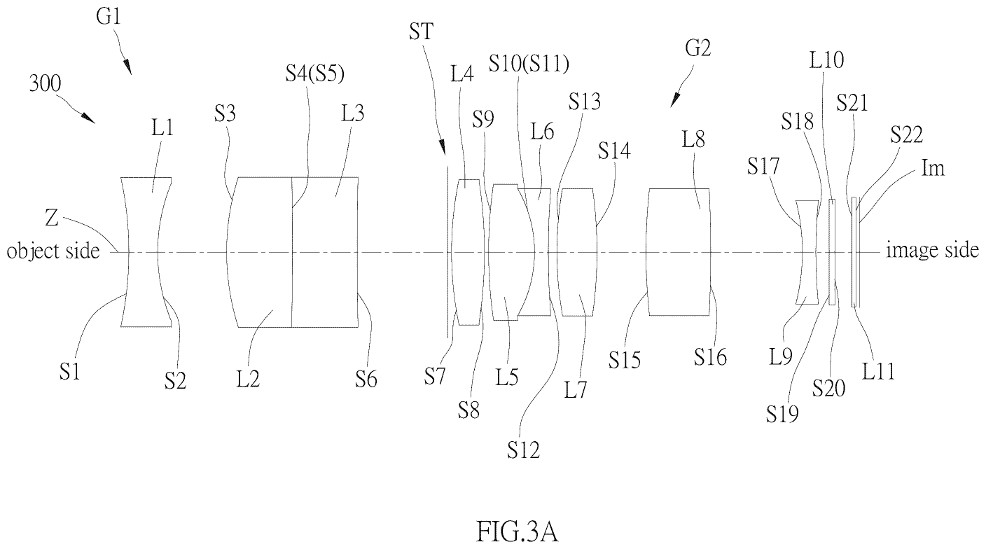

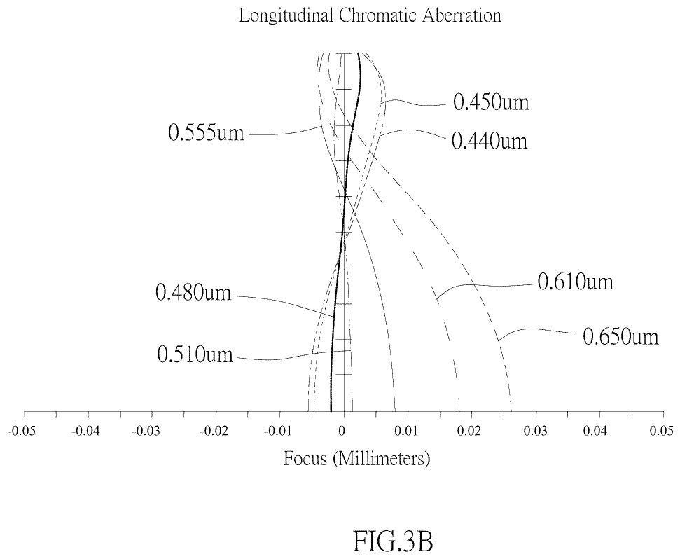

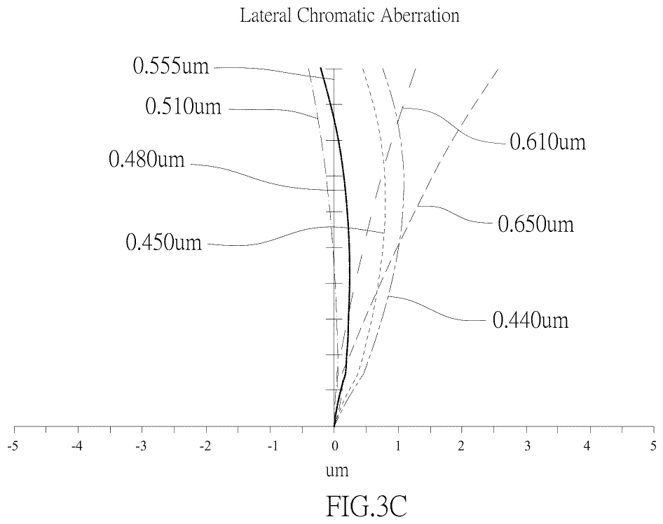

An optical imaging lens 300 according to a third embodiment of the present invention is illustrated in FIG. 3A, which includes, in order along an optical axis Z from an object side to an image side, a first lens assembly G1, an aperture ST, and a second lens assembly G2. In the third embodiment, the optical imaging lens 300 includes at least nine lenses, wherein the first lens assembly G1 consists of, in order along the optical axis Z from the object side to the image side, a first lens L1, a second lens L2, and a third lens L3. The second lens assembly G2 consists of, in order along the optical axis Z from the object side to the image side, a fourth lens L4, a fifth lens L5, a sixth lens L6, a seventh lens L7, an eighth lens L8, and a ninth lens L9.

The first lens L1 is a biconcave lens with negative refractive power, wherein both of an object-side surface S1 and an image-side surface S2 of the first lens L1 are spherical surfaces; the optical axis Z passes through both of the object-side surface S1 and the image-side surface S2.

The second lens L2 is a biconvex lens with positive refractive power, wherein both of an object-side surface S3 and an image-side surface S4 of the second lens L2 are spherical surfaces; the optical axis Z passes through both of the object-side surface S3 and the image-side surface S4. In the third embodiment, a space is provided between the image-side surface S2 of the first lens L1 and the object-side surface S3 of the second lens L2. In other words, the image-side surface S2 of the first lens L1 and the object-side surface S3 of the second lens L2 are not adhered.

The third lens L3 is a biconcave lens with negative refractive power, wherein both of an object-side surface S5 and an image-side surface S6 of the third lens L3 are spherical surfaces; the optical axis Z passes through both of the object-side surface S5 and the image-side surface S6. In the third embodiment, the object-side surface S5 of the third lens L3 and the image-side surface S4 of the second lens L2 are correspondingly adhered to form a compound lens having positive refractive power.

The fourth lens L4 is a biconvex lens with positive refractive power, wherein both of an object-side surface S7 and an image-side surface S8 of the fourth lens L4 are aspheric surfaces; the optical axis Z passes through both of the object-side surface S7 and the image-side surface S8. In the third embodiment, a space is provided between the image-side surface S6 of the third lens L3 and the object-side surface S7 of the fourth lens L4. In other words, the image-side surface S6 of the third lens L3 and the object-side surface S7 of the fourth lens L4 are not adhered.

The fifth lens L5 is a biconvex lens with positive refractive power, wherein both of an object-side surface S9 and an image-side surface S10 of the fifth lens L5 are spherical surfaces; the optical axis Z passes through both of the object-side surface S9 and the image-side surface S10. In the third embodiment, a space is provided between the image-side surface S8 of the fourth lens L4 and the object-side surface S9 of the fifth lens L5. In other words, the image-side surface S8 of the fourth lens L4 and the object-side surface S9 of the fifth lens L5 are not adhered.

The sixth lens L6 is a biconcave lens with negative refractive power, wherein both of an object-side surface S11 and an image-side surface S12 of the sixth lens L6 are spherical surfaces; the optical axis Z passes through both of the object-side surface S11 and the image-side surface S12. In the third embodiment, the object-side surface S11 of the sixth lens L6 and the image-side surface S10 of the fifth lens L5 are correspondingly adhered to form a compound lens having negative refractive power.

The seventh lens L7 is a biconvex lens with positive refractive power, wherein both of an object-side surface S13 and an image-side surface S14 of the seventh lens L7 are spherical surfaces; the optical axis Z passes through both of the object-side surface S13 and the image-side surface S14. In the third embodiment, a space is provided between the image-side surface S12 of the sixth lens L6 and the object-side surface S13 of the seventh lens L7. In other words, the image-side surface S12 of the sixth lens L6 and the object-side surface S13 of the seventh lens L7 are not adhered.

The eighth lens L8 is a biconvex lens with positive refractive power, wherein both of an object-side surface S15 and an image-side surface S16 of the eighth lens L8 are spherical surfaces; the optical axis Z passes through both of the object-side surface S15 and the image-side surface S16. In the third embodiment, a space is provided between the image-side surface S14 of the seventh lens L7 and the object-side surface S15 of the eighth lens L8. In other words, the image-side surface S14 of the seventh lens L7 and the object-side surface S15 of the eighth lens L8 are not adhered.

The ninth lens L9 is a biconcave lens with negative refractive power, wherein both of an object-side surface S17 and an image-side surface S18 of the ninth lens L9 are spherical surfaces; the optical axis Z passes through both of the object-side surface S17 and the image-side surface S18. A space is provided between the image-side surface S16 of the eighth lens L8 and the object-side surface S17 of the ninth lens L9. In other words, the image-side surface S16 of the eighth lens L8 and the object-side surface S17 of the ninth lens L9 are not adhered.

Additionally, the optical imaging lens 300 further includes an infrared filter L10 and a protective glass L11, wherein the infrared filter L10 forms an object-side surface S19 facing the object side and an image-side surface S20 facing the image side. The infrared filter L10 is disposed on one side of the image-side surface S18 of the ninth lens L9, thereby restricting infrared rays passing through the optical imaging lens 300 to improve the quality and fidelity of the image. The protective glass L11 forms an object-side surface S21 facing the object side and an image-side surface S22 facing the image side. The protective glass L11 is disposed on one side of the infrared filter L10 and is located between the infrared filter L10 and an image plane Im to protect the infrared filter L10.

In order to keep the optical imaging lens 300 in good optical performance and high imaging quality, the optical imaging lens 300 satisfies:

$$- 1.1 < F / f 1 < - 0.4 ; \qquad ( 1 )$$

$$0.45 < F / f 2 < 0.9 , - 0.68 < F / f 3 < - 0.01 , 0.28 < F / f 23 < 0.7 ; \qquad ( 2 )$$

$$0.39 < F / f 4 < 0.96 ; \qquad ( 3 )$$

$$0.78 < F / f 5 < 1.1 , - 2.4 < F / f 6 < - 1.3 , - 1.2 < F / f 56 < - 0.38 ; \qquad ( 4 )$$

$$0.48 < F / f 7 < 1.23 ; \qquad ( 5 )$$

$$0.38 < F / f 8 < 1.1 ; \qquad ( 6 )$$

$$- 1.38 < F / f 9 < - 0.62 ; \qquad ( 7 )$$

$$- 0.7 < F / fg 1 < - 0.01 ; \qquad ( 8 )$$

$$0.6 < F / fg 2 < 1.15 . \qquad ( 9 )$$

wherein F is a focal length of the optical imaging lens 300; f1 is a focal length of the first lens L1; f2 is a focal length of the second lens L2; f3 is a focal length of the third lens L3; f23 is a focal length (cemented focal length) of the compound lens formed by adhering the second lens L2 and the third lens L3; f4 is a focal length of the fourth lens L4; f5 is a focal length of the fifth lens L5; f6 is a focal length of the sixth lens L6; f56 is a focal length (cemented focal length) of the compound lens formed by adhering the fifth lens L5 and the sixth lens L6; f7 is a focal length of the seventh lens L7; f8 is a focal length of the eighth lens L8; f9 is a focal length of the ninth lens L9; fg1 is a focal length of the first lens assembly G1; fg2 is a focal length of the second lens assembly G2.

Parameters of the optical imaging lens 300 of the third embodiment of the present invention are listed in following Table 5, including the focal length F of the optical imaging lens 300 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, the focal length (cemented focal length) of the compound lens formed by adhering the second lens L2 and the third lens L3, and the focal length (cemented focal length) of the compound lens formed by adhering the fifth lens L5 and the sixth lens L6, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 5
F = 23.10 mm; Fno = 2.00; FOV = 34.91 deg

| | | | | | | Cemented | |
|---|---|---|---|---|---|---|---|
| | | | | | Focal | focal | |
| Surface | R(mm) | D(mm) | Nd | Vd | length | length | Note |
| S1 | −43.11 | 3.50 | 1.58 | 41.51 | −24.75 | | First lens L1 |
| S2 | 21.87 | 8.63 | | | | | |
| S3 | 32.23 | 8.00 | 1.85 | 23.83 | 36.01 | 38.83 | Second lens L2 |
| S4, S5 | −500.00 | 8.00 | 1.57 | 42.82 | −401.09 | | Third lens L3 |
| S6 | 420.00 | 11.15 | | | | | |
| ST | INFINITY | 0.50 | | | | | Aperture ST |
| S7 | 47.93 | 4.00 | 1.58 | 59.39 | 46.73 | | Fourth lens L4 |
| S8 | −61.21 | 0.50 | | | | | |
| S9 | 56.89 | 5.67 | 1.50 | 81.61 | 25.79 | −47.06 | Fifth lens L5 |
| S10, S11 | −16.00 | 1.70 | 1.85 | 24.80 | −16.03 | | Sixth lens L6 |
| S12 | 100.00 | 1.00 | | | | | |
| S13 | 40.99 | 5.00 | 1.62 | 60.32 | 38.99 | | Seventh lens L7 |
| S14 | −56.27 | 6.04 | | | | | |
| S15 | 71.54 | 8.00 | 1.96 | 17.47 | 51.42 | | Eighth lens L8 |
| S16 | −150.00 | 11.25 | | | | | |
| S17 | −26.73 | 1.70 | 1.61 | 43.71 | −31.61 | | Ninth lens L9 |
| S18 | 69.04 | 1.63 | | | | | |
| S19 | INFINITY | 0.70 | 1.52 | 64.17 | | | Infrared Filter |
| | | | | | | | L10 |
| S20 | INFINITY | 2.10 | | | | | |
| S21 | INFINITY | 0.50 | 1.52 | 64.17 | | | Protective Glass |
| | | | | | | | L11 |
| S22 | INFINITY | 0.44 | | | | | |
| Im | INFINITY | | | | | | Image Plane Im |

It could be seen from Table 5 that, in the third embodiment, the focal length F of the optical imaging lens 300 is 23.10 mm, and the Fno is 2.00, and the FOV is 34.91 degrees, wherein the focal length f1 of the first lens L1 is −24.75 mm; the focal length f2 of the second lens L2 is 36.01 mm; the focal length f3 of the third lens L3 is −401.09 mm; the focal length f4 of the fourth lens L4 is 46.73 mm; the focal length f5 of the fifth lens L5 is 25.79 mm; the focal length f6 of the sixth lens L6 is −16.03 mm; the focal length 7 of the seventh lens L7 is 38.99 mm; the focal length f8 of the eighth lens L8 is 51.42 mm; the focal length f9 of the ninth lens L9 is −31.61 mm; the focal length f23 (cemented focal length) of the compound lens formed by adhering the second lens L2 and the third lens L3 is 38.83 mm; the focal length f56 (cemented focal length) of the compound lens formed by adhering the fifth lens L5 and the sixth lens L6 is −47.06 mm; the focal length fg1 of the first lens assembly G1 is −187.91 mm; the focal length fg2 of the second lens assembly G2 is 29.20 mm.

Additionally, based on the above detailed parameters, detailed values of the aforementioned conditions (1) to (9) in the third embodiment are as follows:

$$F / f 1 = - 0.933 ; \qquad ( 1 )$$

$$F / f 2 = 0.642 , F / f 3 = - 0.058 , F / f 23 = 0.595 ; \qquad ( 2 )$$

$$F / f 4 = 0.494 ; \qquad ( 3 )$$

$$F / f 5 = 0.896 , F / f 6 = - 1.441 , F / f 56 = - 0.491 ; \qquad ( 4 )$$

$$F / f 7 = 0.592 ; \qquad ( 5 )$$

$$F / f 8 = 0.449 ; \qquad ( 6 )$$

$$F / f 9 = - 0.731 ; \qquad ( 7 )$$

$$F / fg 1 = - 0.123 ; \qquad ( 8 )$$

$$F / fg 2 = 0.791 . \qquad ( 9 )$$

With the parameters from Table 5, in the third embodiment, the focal length fg1 of the first lens assembly G1, the focal length fg2 of the second lens assembly G2, the focal length of each lens, the focal length (cemented focal length) of the compound lens formed by adhering the second lens L2 and the third lens L3, and the focal length (cemented focal length) of the compound lens formed by adhering the fifth lens L5 and the sixth lens L6 satisfy the aforementioned conditions (1) to (9) of the optical imaging lens 300.

Additionally, the optical imaging lens 300 further satisfies:

$$f / ( f 1 + f 2 + f 3 ) = - 0.06 ; f / ( f 4 + f 5 + f 6 + f 7 + f 8 + f 9 ) = 0.2 .$$

Moreover, an aspheric surface contour shape Z of each of the object-side surface S7 of the fourth lens L4, and the image-side surface S8 of the fourth lens L4 according to the third embodiment could be obtained by following formula:

$$Z = \frac{{ch}^{2}}{1 + \sqrt{1 - ( 1 + k ) {c}^{2} {h}^{2}}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14 and A16 respectively represents different order coefficient of h.

In the optical imaging lens 300 according to the third embodiment, the conic constant k of each of the aspheric surfaces and the different order coefficient of A2, A4, A6, A8, A10, A12, A14, and A16 are listed in following Table 6:

TABLE 6

| Surface | S7 | S8 |
|---|---|---|
| k | 0.0000E+00 | 0.0000E+00 |
| A2 | 0.0000E+00 | 0.0000E+00 |
| A4 | 1.7180E−06 | −3.5081E−06 |
| A6 | 3.0530E−08 | 9.3045E−09 |
| A8 | 6.6921E−10 | 5.9001E−10 |
| A10 | −1.3266E−11 | −1.4984E−11 |
| A12 | 1.0669E−13 | 1.3312E−13 |
| A14 | −4.4736E−17 | −1.8913E−16 |
| A16 | −1.71297E−18 | −1.68331E−18 |

Taking optical simulation data to verify the imaging quality of the optical imaging lens 300, wherein FIG. 3B is a diagram showing the longitudinal chromatic aberration according to the third embodiment. From FIG. 3B, it could be observed that the curves formed by each wavelength are close to one another, thereby significantly enhancing chromatic aberration. The skewness of each curve shows that the deviation of the imaging points of off-axis rays is controlled within the range of ±0.03 millimeters. Therefore, in the third embodiment, chromatic aberration for different wavelengths is significantly improved.

The lateral chromatic aberration according to the third embodiment is illustrated in FIG. 3C. From FIG. 3C, it could be observed that the lateral chromatic aberration of both the shortest wavelength and the longest wavelength irradiating on the image plane is less than 3 micrometers, indicating that the optical imaging lens 300 has low lateral chromatic aberration. The rays of different wavelengths tend to converge at the image plane, thereby improving color accuracy and image quality.

It must be pointed out that the embodiments described above are only some preferred embodiments of the present invention. It is noted that, the parameters listed in Tables are not a limitation of the present invention. All equivalent structures which employ the concepts disclosed in this specification and the appended claims should fall within the scope of the present invention.

What is claimed is:

1. An optical imaging lens, in order from an object side to an image side along an optical axis, comprising:
a first lens assembly consisting of, in order from the object side to the image side along the optical axis, a first lens having negative refractive power, a second lens having positive refractive power, and a third lens having negative refractive power, wherein the first lens is a biconcave lens;
an aperture;
a second lens assembly consisting of, in order from the object side to the image side along the optical axis, a fourth lens having positive refractive power, a fifth lens having positive refractive power, a sixth lens having negative refractive power, a seventh lens having positive refractive power, an eighth lens having positive refractive power, and a ninth lens having negative refractive power.

2. The optical imaging lens as claimed in claim 1, wherein the second lens is a biconvex lens; the third lens is a biconcave lens.

3. The optical imaging lens as claimed in claim 1, wherein the optical imaging lens satisfies: −1.1<F/f1<−0.4, wherein F is a focal length of the optical imaging lens; f1 is a focal length of the first lens.

4. The optical imaging lens as claimed in claim 1, wherein the optical imaging lens satisfies: 0.45<F/f2<0.9, wherein F is a focal length of the optical imaging lens; f2 is a focal length of the second lens.

5. The optical imaging lens as claimed in claim 1, wherein the optical imaging lens satisfies: −0.68<F/f3<−0.01, wherein F is a focal length of the optical imaging lens; f3 is a focal length of the third lens.

6. The optical imaging lens as claimed in claim 1, wherein the optical imaging lens satisfies: −0.7<F/fg1<−0.01, wherein F is a focal length of the optical imaging lens; fg1 is a focal length of the first lens assembly.

7. The optical imaging lens as claimed in claim 1, wherein the fifth lens is a biconvex lens; the sixth lens is a biconcave lens; the seventh lens is a biconvex lens; the eighth lens is a biconvex lens; the ninth lens is a biconcave lens.

8. The optical imaging lens as claimed in claim 1, wherein the optical imaging lens satisfies: 0.39<F/f4<0.96, wherein F is a focal length of the optical imaging lens; f4 is a focal length of the fourth lens.

9. The optical imaging lens as claimed in claim 1, wherein an object-side surface and an image-side surface of the fourth lens are aspheric surfaces.

10. The optical imaging lens as claimed in claim 1, wherein the optical imaging lens satisfies: 0.78<F/f5<1.1, wherein F is a focal length of the optical imaging lens; f5 is a focal length of the fifth lens.

11. The optical imaging lens as claimed in claim 1, wherein the optical imaging lens satisfies: −2.4<F/f6<−1.3, wherein F is a focal length of the optical imaging lens; f6 is a focal length of the sixth lens.

12. The optical imaging lens as claimed in claim 1, wherein the optical imaging lens satisfies: 0.48<F/f7<1.23, wherein F is a focal length of the optical imaging lens; f7 is a focal length of the seventh lens.

13. The optical imaging lens as claimed in claim 1, wherein the optical imaging lens satisfies: 0.38<F/f8<1.1, wherein F is a focal length of the optical imaging lens; f8 is a focal length of the eighth lens.

14. The optical imaging lens as claimed in claim 1, wherein the optical imaging lens satisfies: −1.38<F/f9<−0.62, wherein F is a focal length of the optical imaging lens; f9 is a focal length of the ninth lens.

15. The optical imaging lens as claimed in claim 1, wherein the optical imaging lens satisfies: 0.6<F/fg2<1.15, wherein F is a focal length of the optical imaging lens; fg2 is a focal length of the second lens assembly.

16. An optical imaging lens, in order from an object side to an image side along an optical axis, comprising:
a first lens assembly consisting of, in order from the object side to the image side along the optical axis, a first lens having negative refractive power, a second lens, and a third lens, wherein the first lens is a biconcave lens; an image-side surface of the second lens and an object-side surface of the third lens are adhered to form a compound lens having positive refractive power;
an aperture;
a second lens assembly consisting of, in order from the object side to the image side along the optical axis, a fourth lens having positive refractive power, a fifth lens, a sixth lens, a seventh lens having positive refractive power, an eighth lens having positive refractive power, and a ninth lens having negative refractive power, wherein an image-side surface of the fifth lens and an object-side surface of the sixth lens are adhered to form a compound lens having negative refractive power.

17. The optical imaging lens as claimed in claim 16, wherein the optical imaging lens satisfies: 0.28<F/f23<0.7, wherein F is a focal length of the optical imaging lens; f23 is a focal length of the compound lens formed by adhering the second lens and the third lens.

18. The optical imaging lens as claimed in claim 17, wherein the optical imaging lens satisfies: −1.2<F/f56<−0.38, wherein F is a focal length of the optical imaging lens; f56 is a focal length of the compound lens formed by adhering the fifth lens and the sixth lens.

19. The optical imaging lens as claimed in claim 16, wherein the second lens is a biconvex lens; the third lens is a biconcave lens.

20. The optical imaging lens as claimed in claim 16, wherein the fifth lens is a biconvex lens; the sixth lens is a biconcave lens; the seventh lens is a biconvex lens; the eighth lens is a biconvex lens; the ninth lens is a biconcave lens.

21. The optical imaging lens as claimed in claim 16, wherein an object-side surface and an image-side surface of the fourth lens are aspheric surfaces.

22. The optical imaging lens as claimed in claim 17, wherein the optical imaging lens satisfies: −0.7<F/fg1<−0.01, wherein F is a focal length of the optical imaging lens; fg1 is a focal length of the first lens assembly.

23. The optical imaging lens as claimed in claim 17, wherein the optical imaging lens satisfies: 0.6<F/fg2<1.15, wherein F is a focal length of the optical imaging lens; fg2 is a focal length of the second lens assembly.
